(19) United States
(12) Patent Application Publication
(10) Pub. No.: US 2014/0242910 A1
(43) Pub. Date: Aug. 28, 2014

(54) METHOD AND SYSTEM FOR ALLOCATING PERSONAL ELECTRONIC DEVICES TO SEATS IN AN AIRCRAFT

(71) Applicant: AIRBUS OPERATIONS GMBH, Hamburg (DE)

(72) Inventors: Sebastian UMLAUFT, Hamburg (DE); Achim Loock, Hamburg (DE)

(73) Assignee: AIRBUS OPERATIONS GMBH, Hamburg (DE)

(21) Appl. No.: 14/190,823

(22) Filed: Feb. 26, 2014

Related U.S. Application Data
(60) Provisional application No. 61/769,772, filed on Feb. 27, 2013.

(30) Foreign Application Priority Data
Feb. 27, 2013 (DE) 10 2013 203 226.9

(51) Int. Cl. H04W 4/00; H04W 12/06

(52) U.S. Cl. CPC H04W 4/008; H04W 12/06
USPC 455/41.1

(57) ABSTRACT

The present disclosure relates to a method for allocating a personal electronic device (PED) to a seat in an aircraft, including of connecting a PED to a wireless network of the aircraft, identifying the PED to a near-field communications device of a seat of the aircraft, matching and assigning the seat to which the PED has been identified to the connection data of the PED to the wireless network of the aircraft, and unlocking seat-based control functions for the PED via the wireless network of the aircraft.

### CROSS-REFERENCES TO RELATED APPLICATIONS

This application claims the benefit of and priority to the German patent application No. 10 2013 203 226.9, filed Feb. 27, 2013, and U.S. Provisional Application No. 61/769,772, filed Feb. 27, 2013, the entire disclosures of which are incorporated herein by reference.

### TECHNICAL FIELD

The present invention relates to methods and systems for allocating personal electronic devices to seats in an aircraft, in particular by means of seat-bound near-field communication.

### BACKGROUND

Personal electronic devices are becoming more and more widespread, and are also frequently used on-board flights. In view of the multiple communications interfaces of modern electronic devices, it is obvious, on aircrafts too, to grant passengers having devices of this type access to the networks of the aircraft and thus access to electronic control functions of particular parts of the aircraft equipment.

For example, the document EMTEQ, “eConnect”, Technical White Paper 2011, available online at http://www.emteq.com/cmsdocuments/EMTEQ_eConnect.pdf, discloses a universal distribution system for managing access by passengers to control functions of an aircraft via electronic devices.

For personalising access via electronic devices, in other words to make possible targeted access to individualisable control functions for individual passengers, various approaches have been pursued thus far.

Document US 2011/0314489 A1 discloses an aircraft entertainment system comprising a purchase confirmation device via which passengers can select and pay for particular entertainment programmes in a targeted manner. Document US 2011/0314507 A1 discloses an aircraft entertainment system comprising seat display devices, via which tokens can be transmitted to optical sensors of a personal electronic device. Document DE 10 2009 001 366 A1 discloses a method for individually providing functions for a flight passenger, in which the flight passenger identifies himself to an aircraft system via a personalised boarding pass. Document US 2012/0174165 A1 discloses an in-flight entertainment system comprising seat-bound display devices which can be actuated via seat control devices. Document US 2011/0137773 A1 discloses a wireless system for identifying occupants of an aircraft.

### SUMMARY

One idea of the invention is to make access to a wireless network of an aircraft possible using a PED, without it being possible to carry out undesirable control functions using the PED.

In accordance with a first aspect of the invention, a method for allocating a personal electronic device to a seat in an aircraft is provided. The method comprises connecting a PED to a wireless network of the aircraft, identifying the PED to a near-field communications device of a seat of the aircraft, matching and assigning the seat to which the PED has been identified to the connection data of the PED to the wireless network of the aircraft, and unlocking seat-based control functions for the PED via the wireless network of the aircraft.

In accordance with a second aspect of the invention, a system for allocating a personal electronic device, PED, to a seat in an aircraft comprises a plurality of near-field communications devices, which can each be connected to one seat of an aircraft and are assigned to this seat, a wireless network in the aircraft, to which the PED can connect, and a control device, which is connected to the plurality of near-field communications devices and the wireless network, and which is configured so as to identify the PED via one of the near-field communications devices of a seat of the aircraft, to match and assign the seat to which the PED has been identified to the connection data of the PED to the wireless network of the aircraft, and to unlock seat-based control functions for the PED via the wireless network of the aircraft.

In accordance with a third aspect, the invention further provides an aircraft comprising a plurality of seats and a system according to the invention, a near-field communications device of the system being assigned to each of the plurality of seats.

An idea is to link passengers' personal electronic devices to a seat in such a way that upon access by the personal electronic device the scope of access and the control functions of the device can be set selectively as a function of the assigned seat.

This has the advantage that by using his personal electronic device a passenger can only influence the functionalities which are relevant to his own seat. Otherwise, wireless networks have too wide a coverage radius for there to be any possibility of distinguishing between individual passengers and their devices and their position in the aircraft. By way of the additional near-field identification, it is possible for example to prevent passengers from being able to operate operating elements such as seat lights, seat video screens or similar components which are assigned to a seat of a different passenger.

In accordance with one embodiment of the method according to the invention, the method further comprises authenticating the PED via the near-field communications device of the seat of the aircraft.

In accordance with a further embodiment of the method according to the invention, the authentication of the PED comprises assigning the PED to the passenger assigned to the seat of the aircraft.

In accordance with a further embodiment of the method according to the invention, the wireless network is a WLAN.

In accordance with a further embodiment of the method according to the invention, the seat-based control functions for the PED may comprise a control function for the seat light, a control function for calling an attendant, a control function for calling catering, a control function for an online purchase from a duty-free shop, a control function for electronic window tinting, a control function for the seat ventilation, a control function for the in-flight entertainment programme, IFE, a control function for Internet access, a control function for charging the PED via the near-field communications device and/or a control function for an online payment by credit card or loyalty card.

In accordance with a further embodiment of the method according to the invention, the method further comprises checking for the presence of a PED at each seat via the near-field communications device after a flight on the aircraft has ended.

In accordance with a further embodiment of the method according to the invention, the method further comprises the user of the PED, the flight attendant or a control device of the aircraft terminating the control functions, in particular after a flight on the aircraft has ended.

In accordance with a further embodiment of the method according to the invention, the method further comprises a flight attendant selectively switching off particular control functions of the PED via the wireless network of the aircraft during critical flight phases of the aircraft.

In accordance with a further embodiment of the method according to the invention, the PED may be a laptop, mobile phone, smartphone, handheld, palmtop or tablet or an aircraft-specific operating device.

### BRIEF DESCRIPTION OF THE DRAWINGS

In the following, the invention is disclosed in greater detail in relation to and with reference to the embodiments illustrated in the appended drawings.

The appended drawings are for an improved understanding of the present invention, and illustrate example variant embodiments of the invention. They serve to explain principles, advantages, technical effects and possible variations. Naturally, other embodiments and many of the intended advantages of the invention are equally conceivable, in particular in view of the detailed description of the invention given in the following. The elements of the drawings are not necessarily shown to scale, and in some cases are shown in a simplified form or schematically for reasons of clarity. In this context, like reference numerals denote like or similar components or elements.

FIG. 1 is a schematic drawing of a personal electronic device comprising a near-field communications device in accordance with an embodiment of the invention.

FIG. 2 is a schematic drawing of a personal electronic device comprising a connected near-field communications device in accordance with a further embodiment of the invention.

FIG. 3 is a schematic drawing of an aircraft comprising seat-bound near-field communication in accordance with a further embodiment of the invention.

FIG. 4 is a schematic drawing of a row of seats in an aircraft comprising seat-bound near-field communication in accordance with a further embodiment of the invention.

FIG. 5 is a schematic drawing of a method for allocating personal electronic devices to seats in an aircraft in accordance with a further embodiment of the invention.

### DETAILED DESCRIPTION

Although special embodiments are disclosed and shown herein, it is clear to a person skilled in the art that a wide range of further alternative and/or equivalent implementations for the embodiments may be selected without substantially deviating from the basic concept of the present invention. In general, all variations on, modifications of and alterations to the embodiments disclosed herein are also intended to be covered by the invention.

Personal electronic devices (PEDs) within the meaning of the present invention comprise all electronic appliances which can be used for purposes of entertainment, communication and/or office work. For example, PEDs may comprise all forms of consumer terminals such as laptops, mobile phones, smartphones, handhelds, palmtops, tablets, GPS devices, navigation devices, audio equipment such as MP3 players, portable DVD/Blu-ray players or digital cameras.

Near-field communication within the meaning of the present invention denotes any type of contactless communication between two communications devices which are arranged in relative spatial proximity to one another and which can exchange information and/or data using a predefined communications protocol during this temporary spatial proximity. For example, the spatial distance between the communications devices within which data exchange is possible may be a few centimetres, for example less than 15 cm, less than 10 cm or less than 5 cm. Near-field communication within the meaning of the present invention may take place via RFID chips, transceiver antennae, transceiver coils or similar transceiver devices. For example, near-field communication may take place either between an active communications device, in other words one which actively initiates communication, and a passive communications device or between two active communications devices, in other words in what is known as a peer-to-peer mode.

Seats within the meaning of the present invention comprise all devices assigned to a passenger on an aircraft during occupancy which are provided for personal use by the passenger at least for the duration of a flight. For example, seats may comprise conventional aircraft seats, but also loungers, armchairs, beds, first-class suites or similar passenger furniture.

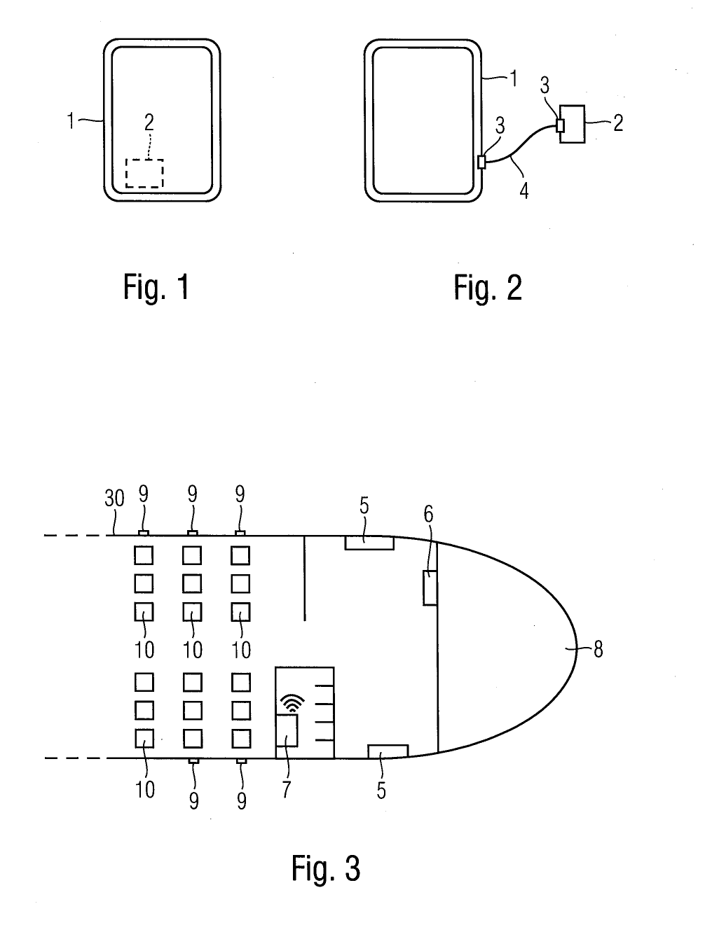

FIG. 1 is a schematic drawing of a PED 1 comprising a near-field communications device 2. The near-field communications device 2 may for example be a wireless transceiver device comprising a transceiver coil which is embedded in the PED 1.

FIG. 2 is a further schematic drawing of a PED 1 comprising a near-field communications device 2, which in this embodiment is connected to the PED 1 via a USB cable 4 between a USB port 3 of the PED 1 and a USB port 3 of the near-field communications device 2. Naturally, other connection options between the PED 1 and the near-field communications device 2 may also be used, for example a Bluetooth® connection, a FireWire connection, a serial interface connection or other suitable communication paths.

FIG. 3 is a schematic drawing of part of an aircraft 30 comprising seat-bound near-field communication. The aircraft 30 comprises a cockpit region 8 and a residence region for flight staff, which may for example use a flight attendant panel 6 (FAP) for controlling various cabin systems. The aircraft 30 comprises for example two doors 5 and a plurality of rows of aircraft seats 10. Portholes or windows 9 may further be provided in the aircraft 30, for example adjacent to the outer seats 10 of each row of seats.

The aircraft 30 further comprises a control device 7 via which a wireless network of the aircraft can be controlled. The wireless network may for example comprise a WIFI network, a WLAN network, a UMTS network, a GSM network, a WiMAX network, a ZigBee network or another suitable network for wireless communication. Via the wireless network of the aircraft 30, passengers who have PEDs 1, as shown for example in FIGS. 1 and 2, can use wireless communication options to selected or unlocked cabin systems of the aircraft 30 or external networks such as mobile communications networks or the Internet

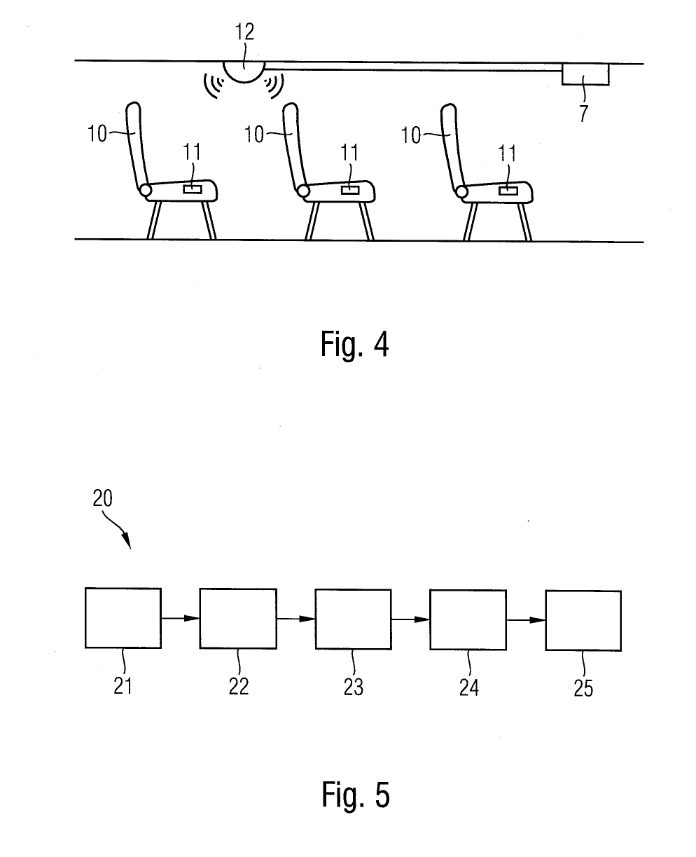

FIG. 4 is a schematic drawing of a row of seats in an aircraft comprising seat-bound near-field communication. In this context, each of the seats 10 may be equipped with a near-field communications device 11, which in each case is assigned to one of the seats 10. The near-field communications devices 11 may for example be integrated into the respective seats 10, for example into an operating panel of the seat 10. However, it may also be possible to apply the near-field communications devices 11 to the seats 10 as separate components, for example to the frames of the seats 10 as shown by way of example in FIG. 4. Further, it may also be possible to apply a near-field communications device 11, which is assigned to a first of the seats 10, to another seat 10, for example to a seat 10 positioned in front of the first of the seats 10, for example in the backrest of the seat 10 positioned in front of the first of the seats 10.

FIG. 4 further shows a network transmission device for the wireless network 12, which is coupled to the control device 7 via a connection.

So as now to connect a PED 1 to the wireless network 12 of the aircraft 30, the PED 1 is initially registered or authenticated with the wireless network 12 in a conventional manner, in such a way that a connection is established between the PED 1 and the wireless network 12 under the control of the control device 7. Subsequently, the near-field communications device 2 is brought within a close spatial distance of one of the near-field communications devices 11 on the seat 10 respectively provided for the user of the PED 1, so as to identify the PED via the respective near-field communications device 11 of the associated seat 10. For this purpose, each of the near-field communications devices 11 is coupled, by wire or wirelessly, to the control device 7 which verifies and logs the respective identification of the PED 1.

The control device 7 can subsequently match the seat 10 at which the PED 1 has been identified to the connection data of the PED 1 to the wireless network 12 of the aircraft 30. The respective wireless network connection of the PED 1 is subsequently assigned to the respective identified seat 10. In this context, if the passenger who is assigned to the respective seat is unknown to the system, the control 7 merely provides a temporary link between the seat 10 and the wireless network connection of the PED 1. However, if the passenger is known to the system, for example on the basis of booking data, frequent flier programme information, boarding pass identification or similar measures, a link to the passenger data is also produced, as well as the link between the seat 10 and the wireless network connection of the PED 1. The additional passenger information can be used for providing further passenger-bound services.

Optionally, the control device 7 may further be configured so as to authenticate the PED 1 via the near-field communications device 11 of the seat 10 of the aircraft 30. For this purpose, the control device 7 may require the entry of authentication information such as a PIN code, a booking number or similar data via the PED 1, which has to be input by the user of the PED 1 on demand. Alternatively, the control device 7 may also provide the authentication automatically by matching authentication information stored on the PED 1, such as for example a MAC address, an IP address, a device PIN or other equivalent data.

Once the seat 10 has been assigned to the wireless network connection of the PED 1, the control device 7 can unlock seat-bound control functions for the PED 1 via the wireless network 12 of the aircraft 30.

The seat-bound control functions for the PED 1 may for example comprise a control function for the seat light, by means of which a passenger can operate the lighting element assigned to his seat. Further, via the PED 1 the passenger can actuate a call for a flight attendant or catering, which can be assigned to his seat 10 in the FAP 6. Via the PED 1, the passenger can make an online purchase from a duty-free shop or other flight sales programme, it being possible to individualise the online purchase given knowledge of passenger information, for example by way of a targeted offer of goods and services tailored to the nationality, gender or religious affiliation of the passenger.

Via the PED 1, the passenger can further carry out control functions for electronic window tinting or for seat ventilation which are assigned to his seat 10. Further, by means of the wireless network connection the in-flight entertainment system (IFE), which engages specifically for the seat 10 in question, can be controlled in a targeted manner. In this context, it may be provided that the user can download multimedia content onto the PED 1 via the wireless network connection. For example, for this purpose it may be necessary for the PED 1 to remain in permanent communicational contact with the near-field communications device 11, so as to ensure that said device is able to download. Alternatively, the PED 1 may remain assigned to the near-field communications device 11 for the purposes of IFE control until another PED 1 accesses the near-field communications device 11 of the same seat 10, for example if the passenger changes. The IFE control offer may also be made dependent on classes of booking, in such a way that more IFE content is made available to passengers in a higher class of booking.

Further, a control function for Internet access, a control function for charging the PED 1 via the near-field communications device 11 and/or a control function for an online payment by credit card or loyalty card may also be provided by the control device 7 as a function of class of booking.

In addition, depending on the connected PED 1 and/or the assigned passenger, advertising offers can be transmitted to the PED 1 via the wireless network 12, for example car hire offers, advertising based on the type of PED or advertising based on the flight destination. If desired by the users of the PEDs 1, the control device 7 may also grant PEDs 1 which are assigned to different seats 10 options for communicating with one another, in such a way that a user of a PED 1 of a first seat 10 can send chat messages to a user of a further PED 1 of a second seat 10, or can make contact with him over the wireless network 12 via telephony or video-telephony services.

In critical flight situations, such as during take-off and landing or in the event of turbulence, the flight attendants can instruct the control device 7, via the flight attendant operating unit 6, to withdraw particular control functions again temporarily from all of the registered PEDs 1 or from PEDs assigned to particular individual seats 10. For example, the mobile communications functionality of the PEDs 1 can be restricted in critical flight phases, for example by switching off the wireless network of the aircraft 30.

PEDs 1 which belong to the aircraft 30 or to the airline operating the aircraft can be logged out again via the near-field communications device 11. As a result, after a flight has ended it can be checked via the control device 7 whether all of the PEDs 1 are located correctly on or by the appropriate seats 10. When collecting up the PEDs 1 from the seats 10, the flight attendants may have corresponding authorisation cards having a near-field communications facility, by means of which it is possible to log the PEDs 1 out from the respective seats 10.

In this context, it is possible for the user of the PED 1, the flight attendant or the control device 7 of the aircraft 30 to terminate the control functions, in particular after a flight on the aircraft 30 has ended.

FIG. 5 is a schematic drawing of a method 20 for allocating personal electronic devices to seats in an aircraft, for example an aircraft 30 as shown in connection with FIGS. 3 and 4.

At 21, the method 20 comprises connecting a PED 1 to a wireless network 12 of the aircraft 30. At 22, the PED 1 is identified to a near-field communications device 11 of a seat 10 of the aircraft 30.

Optionally, it is possible at 23 to authenticate the PED 1 via the near-field communications device 11 of the seat 10 of the aircraft 30, for example by assigning the PED 1 to the passenger assigned to the seat 10 of the aircraft 30.

At 24, the seat 10 to which the PED has been identified is matched and assigned to the connection data of the PED 1 to the wireless network 12 of the aircraft 30, in such a way that, at 25, seat-based control functions can be unlocked for the PED 1 via the wireless network 12 of the aircraft 30.

What is claimed is:

1. A method for allocating a personal electronic device (PED), to a seat in an aircraft, comprising:
connecting a PED to a wireless network of the aircraft; identifying the PED to a near-field communications device of a seat of the aircraft;
matching and allocating the seat to which the PED has been identified to the connection data of the PED to the wireless network of the aircraft; and
unlocking seat-based control functions for the PED via the wireless network of the aircraft.

2. The method according to claim 1, further comprising authenticating the PED via the near-field communications device of the seat of the aircraft.

3. The method according to claim 2, wherein authenticating the PED comprises assigning the PED to the passenger assigned to the seat of the aircraft.

4. The method according to claim 1, wherein the wireless network is a WLAN.

5. The method according to claim 1, wherein the seat-based control functions for the PED comprise a control function for the seat light, a control function for calling an attendant, a control function for calling catering, a control function for an online purchase from a duty-free shop, a control function for electronic window tinting, a control function for the seat ventilation, a control function for the in-flight entertainment programme (IFE) a control function for Internet access, a control function for charging the PED via the near-field communications device and/or a control function for an online payment by credit card or loyalty card.

6. The method according to claim 1, further comprising checking for the presence of a PED at each seat via the near-field communications device after a flight on the aircraft has ended.

7. The method according to claim 1, further comprising a flight attendant selectively switching off particular control functions of the PED via the wireless network of the aircraft in critical flight phases of the aircraft.

8. The method according to claim 1, wherein the PED is a laptop, mobile phone, smartphone, handheld, palmtop or tablet or an aircraft-specific operating device.

9. The method according to claim 1, further comprising a user of the PED, flight attendant or a control device of the aircraft terminating the control functions, in particular after a flight on the aircraft has ended.

10. A system for allocating a personal electronic device (PED), to a seat in an aircraft, the system comprising:
a plurality of near-field communications devices, which can each be connected to one seat of an aircraft and are assigned to this seat; a wireless network in the aircraft, to which the PED can connect; and
a control device, which is connected to the plurality of near-field communications devices and the wireless network, and which is configured so as to identify the PED via one of the near-field communications devices of a seat of the aircraft, to match and assign the seat to which the PED has been identified to the connection data of the PED to the wireless network of the aircraft, and to unlock seat-based control functions for the PED via the wireless network of the aircraft.

11. The system according to claim 10, wherein the control device is further configured so as to authenticate the PED via the near-field communications device of the seat of the aircraft.

12. The system according to claim 10, wherein the wireless network is a WLAN.

13. The system according to claim 10, wherein the seat-based control functions for the PED comprise a control function for the seat light, a control function for calling an attendant, a control function for calling catering, a control function for an online purchase from a duty-free shop, a control function for electronic window tinting, a control function for the seat ventilation, a control function for the in-flight entertainment programme, IFE, a control function for Internet access, a control function for charging the PED via the near-field communications device and/or a control function for an online payment by credit card or loyalty card.

14. The system according to claim 10, wherein the PED is a laptop, mobile phone, smartphone, handheld, palmtop or tablet or an aircraft-specific operating device.

15. An aircraft, comprising:
a plurality of seats; and
a system according to claim 10, wherein a near-field communications device of the system is assigned to each of the plurality of seats.
